(19) United States
(12) Patent Application Publication
(10) Pub. No.: US 2022/0005412 A1
(43) Pub. Date: Jan. 6, 2022

(54) DISPLAY DEVICE AND DRIVING METHOD THEREOF

(71) Applicant: YUNGU (GU' AN) TECHNOLOGY CO., LTD., Langfang (CN)

(72) Inventor: Hongjun XIE, Langfang (CN)

(73) Assignee: YUNGU (GU' AN) TECHNOLOGY CO., LTD., Langfang (CN)

(21) Appl. No.: 17/475,838

(22) Filed: Sep. 15, 2021

Related U.S. Application Data
(63) Continuation of application No. PCT/CN2020/088348, filed on Apr. 30, 2020.

(30) Foreign Application Priority Data
Aug. 29, 2019 (CN) 201910810271.6

(51) Int. Cl. G09G 3/3233

(52) U.S. Cl. CPC G09G 3/3233; G09G 2320/045; G09G 2300/0465; G09G 2300/0842; G09G 2320/0233; G09G 2310/08; G09G 2310/0291

(57) ABSTRACT

A display device includes: an integration module configured to acquire drive currents outputted by a plurality of pixel driving circuits, perform an integral operation on the drive currents in a detection stage, adjust a sampling signal according to a result of the integral operation, and output the adjusted sampling signal; a drive module configured to output a changing analog data signal to each of the pixel driving circuits in the detection stage; and a processing module configured to output a changing digital data signal to the drive module, and generate compensation data according to the adjusted sampling signal and the changing digital data signal, where the compensation data includes threshold voltage information of drive transistors; and the drive module is further configured to adjust the changing analog data signal and output the adjusted changing analog data signal to the pixel driving circuits according to the compensation data.

### CROSS REFERENCE TO RELATED APPLICATIONS

The present application is a continuation of International Patent Application No. PCT/CN2020/088348, filed on Apr. 30, 2020, which is based on and claims priority to Chinese patent application No. 201910810271.6 filed with the CNIPA on Aug. 29, 2019, disclosures of which are incorporated herein by reference in their entireties.

### TECHNICAL FIELD

The present application relates to the field of display technology and, for example, to a display device and a driving method thereof.

### BACKGROUND

In the active-matrix organic light-emitting diode (AMOLED) flat panel display screen, the light-emitting devices are manufactured using an organic material, and the channel current of the drive transistor in the pixel driving circuit determines the brightness of the light emitted from the light-emitting devices. Therefore, the accurate control of the channel current of the drive transistor has become a key issue in the field of AMOLED driving.

With the increase of operation time of the display panel, there is a problem that different light-emitting devices emit light having different brightness in the display device in a case where the driving voltages are identical, affecting the display uniformity.

### SUMMARY

The present application provides a display device and a driving method thereof to avoid the case of poor display uniformity caused by threshold voltage drift, improve the display uniformity of the display device, and facilitate the increase of the aperture ratio of the display device.

In a first aspect, the present application provides a display device. The display device includes a plurality of pixel driving circuits, a plurality of light-emitting devices, an integration module, a drive module, and a processing module.

Each of the plurality of pixel driving circuits is configured to supply a drive current to a respective one of the plurality of light-emitting devices.

The integration module is configured to acquire drive currents outputted by the plurality of pixel driving circuits, perform an integral operation on the drive currents in a detection stage, output a sampling signal which is subjected to an adjustment performed by the integration module according to an operation result.

The drive module is configured to output a changing analog data signal to each of the plurality of pixel driving circuits in the detection stage.

The processing module is configured to output a changing digital data signal to the drive module, and is further configured to acquire the sampling signal, and generate compensation data according to the sampling signal and the changing digital data signal outputted to the drive module; where the compensation data includes threshold voltage information of a drive transistor in a corresponding one of the plurality of pixel driving circuits, and the analog data signal is acquired by performing a digital-to-analog conversion on the digital data signal by the drive module.

The drive module is further configured to adjust the analog data signal to be outputted to the corresponding one of the plurality of pixel driving circuits according to the compensation data.

In a second aspect, the present application further provides a driving method of a display device. The driving method includes the steps described below.

An integration module acquires drive currents outputted by the plurality of pixel driving circuits, performs an integral operation on the drive currents in a detection stage, and outputs a sampling signal which is subjected to an adjustment performed by the integration module according to an operation result.

A drive module supplies a changing analog data signal to each of the plurality of pixel driving circuits in the detection stage.

A processing module outputs a changing digital data signal to the drive module, acquires the sampling signal, and generates compensation data according to the sampling signal and the changing digital data signal outputted to the drive module; where the compensation data includes threshold voltage information of a drive transistor in a corresponding one of the plurality of pixel driving circuits, and the analog data signal is acquired by performing a digital-to-analog conversion on the digital data signal by the drive module.

The drive module adjusts the analog data signal to be outputted to the corresponding one of the plurality of pixel driving circuits according to the compensation data.

In the technical solutions of the present application, the integration module is configured to acquire drive currents outputted by a plurality of pixel driving circuits, perform an integral operation on the drive currents in a detection stage, and output a sampling signal which is subjected to an adjustment performed by the integration module according to an operation result; the drive module is configured to output a changing analog data signal to each of the plurality of pixel driving circuits in the detection stage; and the processing module is configured to output a changing digital data signal to the drive module, acquire the sampling signal, and generate compensation data according to the sampling signal and the changing digital data signal, where the compensation data includes threshold voltage information of a drive transistor in a corresponding one of the plurality of pixel driving circuits, and the analog data signal is acquired by performing a digital-to-analog conversion on the digital data signal by the drive module; where the drive module is further configured to adjust the analog data signal to be outputted to the corresponding one of the plurality of pixel driving circuits according to the compensation data, thereby avoiding the case of poor display uniformity caused by threshold voltage drift, improving the display uniformity of the display device. In addition, the technical solutions of the present application facilitate the reduction of the number of transistors in the pixel driving circuit, thereby increasing the aperture ratio of the display device.

### BRIEF DESCRIPTION OF DRAWINGS

FIG. 1 is a structural diagram of a display device according to an embodiment of the present application;

FIG. 2 is a drive timing diagram of a display device according to an embodiment of the present application; and

FIG. 3 is a flowchart of a driving method of a display device according to an embodiment of the present application.

### DETAILED DESCRIPTION

In the AMOLED flat panel display screen, the light-emitting devices are manufactured using an organic material, pixel circuits are constructed using thin-film transistors, pixels are arranged in an array, and the display screen is refreshed in a progressive scanning manner. Some thin-film transistors in the pixel circuit operate in a liner area and serve as switches, while some thin-film transistors operate in a saturation area and serve as valves for voltage-controlled currents. The driving transistors operate in the saturation area, the channel current is equivalent to the light-emitting current of the organic light-emitting diode (OLED) device, and different currents lead to different brightness of the light emitted from the pixel. Therefore, the accurate control of the channel current of the driving transistor has become a key issue in the field of AMOLED driving, and the uniformity and stability of both the threshold voltage Vth and mobility μ, of the transistors determine the severity of display non-uniformity. With the increase of operation time of the display panel, the threshold voltage Vth of the thin-film transistor in the pixel circuit is drifted, and the degrees of threshold voltage drift of the different thin-film transistors are different, resulting in different light-emitting devices showing different brightness of the light emitted from the display device in a case where the driving voltages are identical, thereby affecting the display uniformity.

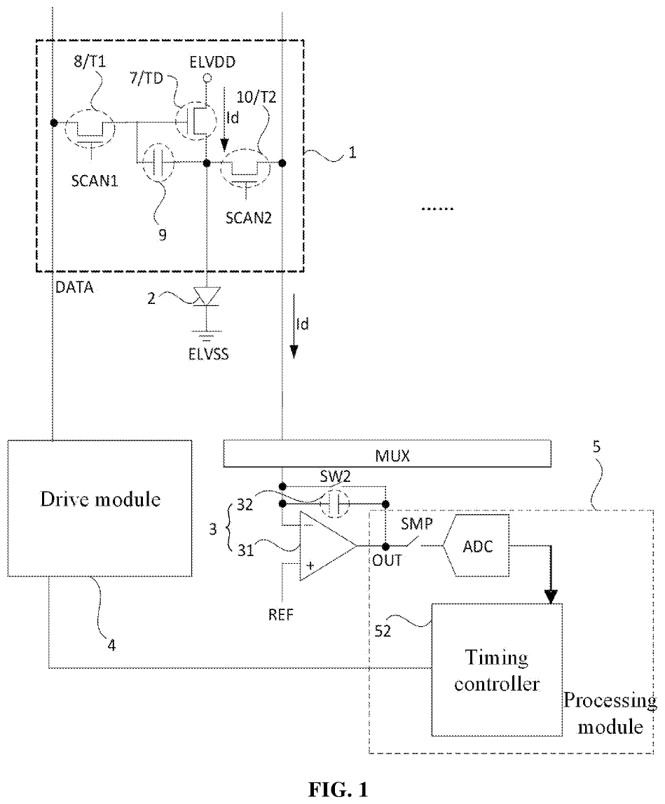

The present application provides a display device. FIG. 1 is a structural diagram of a display device according to an embodiment of the present application. As shown in FIG. 1, the display device includes a plurality of pixel driving circuits 1, a plurality of light-emitting devices 2, an integration module 3, a drive module 4, and a processing module 5. Each of the plurality of pixel driving circuits 1 is configured to supply a drive current to a respective one of the plurality of light-emitting devices 2. The integration module 3 is configured to acquire a drive current Id outputted by a pixel driving circuit of the plurality of pixel driving circuits 1, perform an integral operation on the drive current Id in a detection stage, and output a sampling signal which is subjected to an adjustment performed by the integration module according to an operation result. The drive module 4 is configured to output a changing analog data signal DATA to each of the plurality of pixel driving circuits 1 in the detection stage. The processing module 5 is configured to output a changing digital data signal to the drive module, and is further configured to acquire the sampling signal OUT, and generate compensation data according to the sampling signal OUT and the changing digital data signal outputted to the drive module 4; where the compensation data includes threshold voltage Vth information of a drive transistor TD in a corresponding one of the plurality of pixel driving circuits 1, and the analog data signal is acquired by performing a digital-to-analog conversion on the digital data signal by the drive module 4. The drive module 4 is further configured to adjust the analog data signal DATA to be outputted to the corresponding one of the plurality of pixel driving circuits according to the compensation data.

FIG. 1 illustrates only one pixel driving circuit 1 in the display device and a light-emitting device 2 corresponding to the pixel driving circuit 1. The pixel driving circuit 1 is provided with a drive transistor TD. The drive current Id generated by the drive transistor TD drives the corresponding light-emitting device 2 to emit light in the display stage. In the detection stage, that is, in the stage for detecting the threshold voltage Vth of the drive transistor TD in the pixel driving circuit 1, the drive current Id generated by the drive transistor TD in the pixel driving circuit 1 may be set not to flow through the light-emitting device 2, and all the drive current Id generated by the drive transistor TD in the pixel driving circuit 1 flows into the integration module 3, thereby effectively avoiding the problem that the sampling signal OUT generated by the integration module 3 cannot fully reflect the drive current Id generated by the drive transistor TD due to the partial flow of the drive current Id into the light-emitting device 2 in the detection stage, which in turn makes the processing module 5 fail to generate compensation data that can fully compensate for the threshold voltage Vth of the drive transistor TD, and improving the accuracy of the detection of the threshold voltage Vth of the drive transistor TD in the pixel driving circuit 1.

As shown in FIG. 1, all the drive current Id generated by the drive transistor TD in the pixel driving circuit 1 flows into the integration module 3. The drive module 4 outputs the changing digital analog data DATA to the pixel driving circuit 1 in the detection stage so that the drive current Id generated by the pixel driving circuit is constantly changed. The integration module 3 integrates the drive current Id and outputs the sampling signal OUT. The processing module 5 collects the sampling signal OUT outputted by the integration module 3. With the integration characteristic of the integration module, the processing module 5 may acquire, according to the variation of the sampling signal OUT, the changing digital data signal DATA outputted by the processing module 5 to the drive module 4 when the drive current Id is equal to zero (when the sampling signal OUT does not change, the corresponding drive current Id is equal to zero) to acquire the compensation data. The drive module 4 adjusts the data signal DATA to be outputted according to the compensation data so that the drive current Id is independent of the threshold voltage Vth of the drive transistor TD. Therefore, the problem of poor display uniformity caused by the drift of the threshold voltage Vth is avoided, and the display uniformity of the display device is improved. In addition, in the present application, the integration module 3 and the processing module 5 are used to achieve the external compensation for the threshold voltage Vth of the drive transistor TD in the pixel driving circuit 1, and no more transistors need to be added in the pixel driving circuit 1 to achieve the internal compensation for the threshold voltage Vth of the drive transistor TD, thereby reducing the number of transistors in the pixel driving circuit 1, facilitating the increase of the aperture ratio of the display device, and improving the applicability of the high-Pixels-Per-Inch (PPI) display products. In addition, in the present application, the integration module 3 is set to perform the integration processing on the drive current Id, which belongs to current-type detection. Compared with the voltage-type detection, the transmission of the drive current Id is not affected by line impedance and parasitic capacitance so that the detection has higher accuracy and is more suitable for large-sized display products.

Optionally, as shown in FIG. 1, the integration module 3 includes an operational amplifier 31 and a storage element 32. A non-inverting terminal (+) of the operational amplifier 31 is configured to input a reference signal REF, an inverting terminal (−) of the operational amplifier is configured to input the drive current Id outputted by a respective one of the plurality of pixel driving circuits, and an output terminal of the operational amplifier 31 is configured to output the sampling signal OUT. The inverting terminal (−) of the operational amplifier 31 is electrically connected to the output terminal (+) of the operational amplifier 31 through the storage element 32.

As shown in FIG. 1, the storage element 32 may be a capacitive element, and the inverting terminal (−) of the operational amplifier 31 is electrically connected to the output terminal of the operational amplifier 31 through the storage element 32 so that the operational amplifier 31 achieves the integration function through the storage element 32, that is, the operational amplifier 31 and the storage element 32 form a circuit structure capable of achieving the integration function. The drive current Id is inputted to the inverting terminal (−) of the operational amplifier 31 so that the output voltage Vout of the integration module 3 is in an integral relationship with the drive current Id, and the calculation formula between the two is well known to those skilled in the art, for which, details are not described herein. Since the output voltage Vout of the integration module 3 is in an integral relationship with the drive current Id, the increase or decrease of the drive current Id directly affects the change of the slope of the output voltage Vout of the integration module 3.

The processing module 4 is set to output the changing analog data signal DATA to the pixel driving circuit 1 in the detection stage so that the drive current Id is constantly changing and in turn the slope of the output voltage Vout of the integration module 3 is also changing. When the drive current Id generated by the drive module 4 is zero, according to the integral relationship, the output voltage of the integration module 3 no longer changes. With this characteristic, the processing module 5 acquires the changing digital data signal DATA outputted to the drive module 4 when the drive current Id is zero, and then acquires the threshold voltage Vth of the drive transistor TD. The drive module 4 adjusts the threshold voltage Vth information of the drive transistor TD included in the data signal DATA to be outputted so that the drive current Id is independent of the threshold voltage Vth of the drive transistor TD, thereby avoiding the problem of poor display uniformity caused by the drift of the threshold voltage Vth and improving the display uniformity of the display device.

Optionally, as shown in FIG. 1, the integration module 3 further includes a first switch module SW2. The first switch module SW2 is configured to adjust the integration module 3 to operate in an integration mode or to operate in a follow mode according to an on/off state of the first switch module SW2. Exemplarily, a first terminal of the first switch module SW2 is electrically connected to the inverting terminal (−) of the operational amplifier 31, and a second terminal of the first switch module SW2 is electrically connected to the output terminal of the operational amplifier 31.

As shown in FIG. 1, the first switch module SW2 is connected to the inverting terminal (−) and the output terminal of the operational amplifier 31, that is, the first switch module SW2 is connected in parallel to both terminals of the storage element 32. When the first switch module SW2 is turned off, that is, the first switch module SW2 is in an OFF state, the integration module 3 operates in the integration mode and performs the integration operation on the drive current Id to achieve the external compensation for the threshold voltage Vth of the drive transistor TD in the pixel driving circuit 1. When the first switch module SW2 is turned on, that is, the first switch module SW2 is in an ON state, the storage element 32 is shorted by the first switch module SW2. The integration module 3 operates in the follow mode, that is, the output voltage of the operational amplifier 31 is equal to the voltage of the inverting terminal (−) of the operational amplifier 31, and the non-inverting terminal (+) of the operational amplifier 31 inputs the reference signal REF. Due to the virtual short circuit characteristic of the operational amplifier 31, the voltage of the inverting terminal (−) of the operational amplifier 31 and the output voltage of the operational amplifier 31 are both equal to the voltage of the reference signal REF, and the inverting terminal (−) of the operational amplifier 31 may write the reference signal REF to a corresponding pixel driving circuit 1. Exemplarily, the first switch module SW2 may include a field-effect transistor, and the control of ON and OFF of the first switch module SW2 is achieved by adjusting the gate voltage of the field-effect transistor.

Optionally, as shown in FIG. 1, the processing module 5 includes an analog-to-digital converter ADC and a timing controller 52. The analog-to-digital converter ADC is configured to acquire the sampling signal OUT and convert an analog sampling signal OUT into a digital sampling signal OUT. The timing controller 52 is configured to output the changing digital data signal DATA to the drive module 4, and is further configured to acquire the digital sampling signal OUT and generate the compensation data according to the digital sampling signal OUT and the changing data signal DATA outputted to the drive module 4.

Exemplarily, the timing controller 52 may include a time control register (TCON). The TCON may supply a relevant timing signal and the changing digital data signal DATA to the drive module 4. In addition, the TCON may further supply timing signals to the analog-to-digital converter ADC and the integration module 3. Since the timing controller 52 can only process the digital signal, before the timing controller 52 inputs the sampling signal OUT, the analog-to-digital converter ADC is set to first convert an analog sampling signal OUT to a digital sampling signal OUT and then supply this digital sampling signal OUT to the timing controller 52 to process.

The timing controller 52 acquires the digital sampling signal OUT, and calculates the compensation data according to the digital sampling signal OUT and the changing digital data signal DATA outputted to the drive module 4. The timing controller 52 may acquire, according to the variation of the sampling signal OUT, the changing digital data signal DATA outputted by the processing module 5 to the drive module 4 when the drive current Id is equal to zero (when the sampling signal OUT does not change, the drive current Id is equal to zero). When the drive current Id is equal to zero, the processing module 5 learns that the digital data signal DATA just outputted can make the drive current Id equal to zero, and then extracts the digital data signal DATA for calculating the compensation data. The drive module 4 adjusts the data signal DATA to be outputted according to the compensation data so that the drive current Id is independent of the threshold voltage Vth of the drive transistor TD, thereby avoiding the problem of poor display uniformity caused by the drift of the threshold voltage Vth and improving the display uniformity of the display device.

Optionally, as shown in FIG. 1, the processing module 5 further includes a second switch module SMP. The second switch module SMP is configured to adjust a period during which the processing module 5 receives the sampling signal OUT according to an on/off state of the second switch module SMP. Exemplarily, a first terminal of the second switch module SMP is electrically connected to an output terminal of the integration module 3, and a second terminal of the second switch module SMP is electrically connected to an input terminal of the analog-to-digital converter ADC.

Optionally, as shown in FIG. 1, when the second switch module SMP is turned on, that is, the second switch module SMP is in the ON state, the sampling signal OUT outputted by the integration module 3 is transmitted to the analog-to-digital converter ADC and then is subjected to the analog-to-digital conversion to allow the timing controller 52 to use. When the second switch module SMP is turned off, that is, the second switch module SMP is in the OFF state, the sampling signal OUT outputted by the integration module 3 cannot be transmitted to the analog-to-digital converter ADC and thus cannot be used by the timing controller 52. The drive module 4 outputs the changing analog data signal DATA to the pixel driving circuit 1 in the detection stage. collection on the data signal DATA periods corresponding to different voltages may be performed multiple times by adjusting the on/off state of the second switch module SMP, so as to allow the processing module 5 to compare the sampling signals OUT sampled at two adjacent samplings to determine the changing digital data signal DATA outputted by the processing module 5 to the drive module 4 when the drive current Id is equal to zero. Exemplarily, the second switch module SMP may include a field-effect transistor, and the control of ON and OFF of the second switch module SMP is achieved by adjusting the gate voltage of the field-effect transistor.

Optionally, as shown in FIG. 1, the display device further includes a multi-path selection module MUX. The multi-path selection module MUX is configured to gate one pixel driving circuit 1 of the plurality of pixel driving circuits 1 at one moment to electrically connect the one pixel driving circuit 1 to the integration module 3. FIG. 1 illustrates only one pixel driving circuit 1. The display device may be set to include n columns of pixels, that is, the display device includes n columns of pixel driving circuits 1. The multi-path selection module MUX may be set as an n-to-1 multiplexer, that is, the multiplexer includes n input terminals and one output terminal, where each of the n input terminals is electrically connected to one column of the pixel driving circuits 1, and the output terminal is electrically connected to the integration module 3.

In the detection stage, the multiplexer selects one input terminal to be conducted to the output terminal at one moment, that is, the multiplexer selects one column of pixel driving circuits 1 to electrically connect the one column of pixel driving circuits 1 to the integration module 3 at one time. Since the pixel driving circuits 1 are driven row by row, the detection of the threshold voltage Vth of the drive transistor TD in each pixel driving circuit 1 of this column of pixel driving circuits 1 is achieved. The multiplexer selects another one input terminal to be conducted to the output terminal at the next time, and so on, until all columns of pixel driving circuits 1 are connected to the integration module 3 in turn, so that the detection of the threshold voltage Vth of the drive transistor TD in all the pixel driving circuits 1 is achieved. In this way, with the multiplexer, the detection of the threshold voltage Vth of the drive transistor TD in all the pixel driving circuits 1 can be achieved by using only one integrating module 3 and one processing module 5, which greatly reduces the number of the drive modules 4 and the processing modules 5 in the display device, simplifies the structure of the display device, and facilitates the reduction of the production cost of the display device.

Optionally, as shown in FIG. 1, the pixel driving circuit 1 includes a drive unit 7, a data writing unit 8, a storage unit 9, and a reset unit 10. The drive unit 7 is configured to supply a drive current Id to a respective one of the plurality of light-emitting devices 2 and includes a drive transistor TD. The data writing unit 8 is configured to write the changing analog data signal DATA outputted by the drive module 4 to a control terminal of the drive unit 7. The storage unit 9 is configured to maintain a potential of the control terminal of the drive unit 7. The reset unit 10 is configured to output the drive current Id generated by the drive unit 7 to the integration module 3 in the detection stage. As shown in FIG. 1, a control terminal of the data writing unit 8 inputs a first scan signal SCAN1, and a first terminal of the data writing unit 8 inputs the changing analog data signal DATA outputted by the drive module 4; the control terminal of the drive unit 7 is electrically connected to a second terminal of the data writing unit 8, a first terminal of the drive unit 7 inputs a first power signal ELVDD, a second terminal of the drive unit 7 is electrically connected to a first electrode of the respective one of the plurality of light-emitting devices 2, and a second electrode of the respective one of the plurality of light-emitting devices 2 inputs a second power signal ELVSS; a first terminal of the storage unit 9 is electrically connected to the control terminal of the drive unit 7, and a second terminal of the storage unit 9 is electrically connected to the second terminal of the drive unit 7; and a control terminal of the reset unit 10 inputs a second scan signal SCAN2, a first terminal of the reset unit 10 is electrically connected to the second terminal of the drive unit 7, and a second terminal of the reset unit 10 is electrically connected to the integration module 3.

As shown in FIG. 1, in the detection stage, since the non-inverting terminal (+) of the operational amplifier 31 inputs the reference signal REF and the operational amplifier 31 has the virtual short circuit characteristic, the inverting terminal (−) of the operational amplifier 31 always inputs the reference signal REF. The level value of the reference signal REF may be set to be less than the sum of the level value of the second power signal ELVSS and the level value of the light-emitting device 2 when the light-emitting device 2 is ON so that the light-emitting device 2 does not emit light in the detection stage and the drive current Id does not flow through the light-emitting device 2 but all flows into the integration module 3, which effectively avoids the problem that the sampling signal OUT generated by the integration module 3 cannot fully reflect the drive current Id generated by the drive transistor TD due to the partial flow of the drive current Id into the light-emitting device 2 in the detection stage and thus avoids the problem that the processing module 5 fail to generate the compensation data that can fully compensate for the threshold voltage Vth of the drive transistor TD, thereby improving the accuracy of the detection of the threshold voltage Vth of the drive transistor TD in the pixel driving circuit 1.

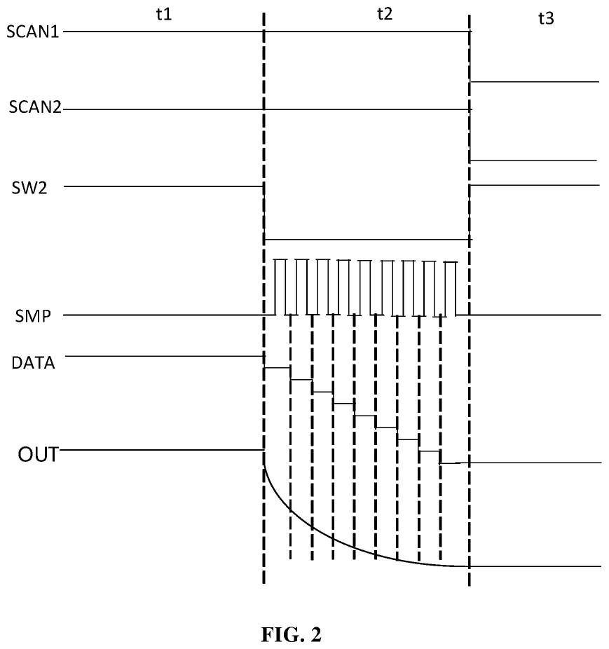

FIG. 2 is a drive timing diagram of a display device according to an embodiment of the present application. The operation principle of the display device will be described in detail below with reference to FIGS. 1 and 2 by using an example in which the transistors included in the pixel driving circuit 1 are all N-type transistors.

The time period t1 is a preparation stage. T1 and T2 are both turned on. The first switch module SW2 is turned on. The second switch module SMP is turned off. The initial voltage of the changing analog data signal DATA outputted by the drive module 4 may be set sufficiently high to ensure that the drive transistor TD is on, for example, the difference between the initial voltage of this data signal DATA and the voltage of the reference signal REF may be set greater than the threshold voltage Vth of the drive transistor. At this point, the channel current of the drive transistor TD is constant current. The level value of the reference signal REF may be set less than the sum of the level value of the second power signal ELVSS and the level value of the light-emitting device 2 when the light-emitting device 2 is ON. The light-emitting device 2 does not emit light. The integration module 3 is a voltage follower. The sampling signal OUT outputted by the integration module 3 is the reference signal REF. All the channel current of the drive transistor TD flows into the voltage follower (that is, the integration module 3). The second switch module SMP is off, and no sampling is performed. In the first time period t1, the data signal DATA initializes the gate potential of the drive transistor TD, and the reference signal REF initializes the source potential of the drive transistor TD, thereby preventing the potential of one node in the previous frame from affecting the potential of the same node in the current frame.

The time period t2 is a detection stage. The first switch module SW2 is turned off. The integration module 3 exits the voltage follower mode and starts to perform integration. The drive module 4 outputs a changing analog data signal DATA in this stage, for example, the voltage of this data signal DATA may be set to be stepped down. Each time after the voltage of this data signal DATA is lowered, the second switch module SMP is controlled to be turned on and perform the sampling once. The analog-to-digital converter ADC converts an analog sampling signal OUT into a digital sampling signal OUT and sends the digital sampling signal OUT to the processing module 5. When the processing module 5 determines that the voltage values of the sampling signals OUT sampled in two adjacent samplings is close to or equal to each other, the processing module 5 determines that the channel current of the drive transistor TD is equal to zero according to the integration principle of the integration module 3. Exemplarily, before the drive current Id becomes equal to zero, the drive current Id is continuously changing. Since the voltage of the data signal DATA is continuously being reduced, the drive current Id is continuously being reduced. According to the integration relationship, the voltage reduction slope of the sampling signal OUT outputted by the integration module 3 is increasingly reduced, and when the drive current Id is equal to zero, the voltage of the sampling signal OUT outputted by the integration module 3 is unchanged. Alternatively, the above may be understood from the point of view of the storage element 32, that is, from the point of view of the capacitor. The drive current Id is continuously being reduced, that is, the channel current of the drive transistor TD is changing to charge the capacitor, and thus the voltage of the sampling signal OUT outputted by the integrating module 3 is changing. When the channel current of the drive transistor TD is equal to zero, the capacitor is not charged or discharged, and the voltage of the sampling signal OUT outputted by the integrating module 3 maintains unchanged. At this point, the processing module 5 acquires the changing digital data signal DATA outputted to the drive module 4, that is, the processing module 5 records the level value of the digital data signal DATA last outputted to the drive module 4. Then the time period t2 ends.

The time period t3 is a final stage. T1 and T2 are both turned off. The first switch module SW2 is turned on. The integration module 3 enters the voltage follower mode. The second switch module SMP is turned off, and no sampling is performed. The detection of the current row of pixels ends. Within the processing module 5, the difference between the recorded level value VDATA of the digital data signal DATA last outputted to the drive module 4 and the level value VREF of the reference signal REF is calculated. Since the difference between VDATA and VREF corresponds to the case where the drive current Id generated by the drive transistor TD is equal to zero, the difference between VDATA and VREF is equal to the threshold voltage Vth of the drive transistor TD.

The threshold voltage Vth of the drive transistor TD in each pixel driving circuit 1 of this row of pixel driving circuits 1 is stored in the drive module 4, for example, all threshold voltages Vth are stored in a driver chip of the drive module 4 for the compensation operation of the display mode. For example, when a certain pixel driving circuit 1 is driven, the voltage of the data signal DATA outputted by the drive module 4 is the acquired corresponding threshold voltage Vth plus the voltage of the original data signal DATA so that the drive current Id is independent of the threshold voltage Vth of the drive transistor TD, thereby avoiding the problem of poor display uniformity caused by the drift of the threshold voltage Vth and improving the display uniformity of the display device.

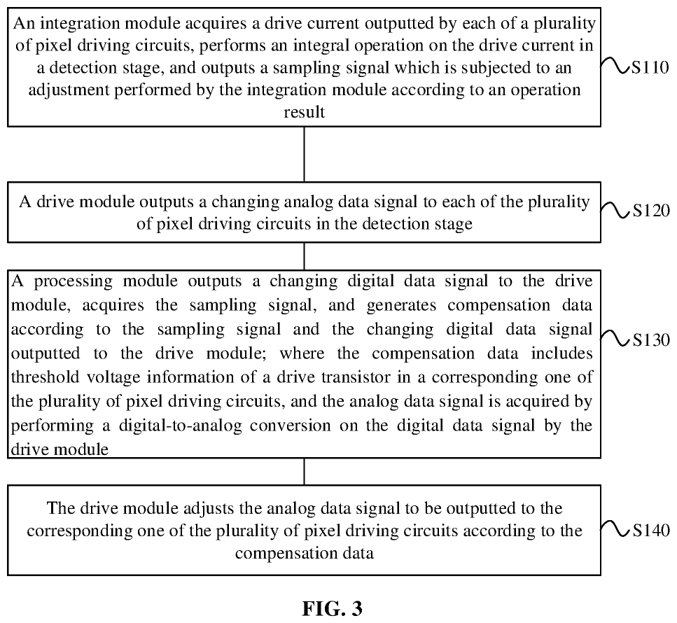

The present application further provides a driving method of a display device. The driving method is executed by the display device described in the above-mentioned embodiments. FIG. 3 is a flowchart of a driving method of a display device according to an embodiment of the present application. As shown in FIG. 3, the driving method includes steps S110 to S140.

In step S110, an integration module acquires a drive current outputted by each of a plurality of pixel driving circuits, performs an integral operation on the drive current in a detection stage, and outputs a sampling signal which is subjected to an adjustment performed by the integration module according to an operation result.

In step S120, a drive module outputs a changing analog data signal to each of the plurality of pixel driving circuits in the detection stage.

Exemplarily, the drive module supplies a data signal whose level value is stepped down to a corresponding one of the plurality of pixel driving circuits in the detection stage.

In step S130, a processing module outputs a changing digital data signal to the drive module, acquires the sampling signal, and generates compensation data according to the sampling signal and the changing digital data signal outputted to the drive module; where the compensation data includes threshold voltage information of a drive transistor in a corresponding one of the plurality of pixel driving circuits, and the analog data signal is acquired by performing a digital-to-analog conversion on the digital data signal by the drive module.

Exemplarily, the processing module compares level values of sampling signals sampled at two adjacent samplings to each other, acquires the changing digital data signal outputted to the drive module at a moment when the level values of the sampling signals sampled at the two adjacent samplings are equal, and acquires the compensation data according to the changing digital data signal outputted to the drive module at the moment.

In S140, the drive module adjusts the analog data signal to be outputted to the corresponding one of the plurality of pixel driving circuits according to the compensation data.

In the present application, the problem of poor display uniformity caused by threshold voltage drift is avoided, the display uniformity of the display device is improved, the external compensation for the threshold voltage of the drive transistor in the pixel driving circuit is achieved using the integration module and the processing module, and no more transistors need to be added in the pixel driving circuit to achieve the internal compensation for the threshold voltage of the drive transistor, thereby reducing the number of transistors in the pixel driving circuit, facilitating the increase of the aperture ratio of the display device, and improving the applicability of the high-PPI display products. In addition, in the present application, the integration module performs the integration processing on the drive current, and this operation belongs to the current-type detection. Compared with the voltage-type detection, in the current-type detection, the transmission of the drive current is not affected by line impedance and parasitic capacitance so that the detection has higher accuracy and is more suitable for large-sized display products.

What is claimed is:

1. A display device, comprising:
a plurality of light-emitting devices;
a plurality of pixel driving circuits, wherein each of the plurality of pixel driving circuits is configured to supply a drive current to a respective one of the plurality of light-emitting devices;
an integration module configured to acquire drive currents outputted by the plurality of pixel driving circuits, perform an integral operation on the drive currents in a detection stage, adjust a sampling signal according to a result of the integral operation, and output the adjusted sampling signal;
a drive module, configured to supply a changing analog data signal to the plurality of pixel driving circuits in the detection stage; and
a processing module, configured to output a changing digital data signal to the drive module and acquire the adjusted sampling signal, and generate compensation data according to the adjusted sampling signal and the changing digital data signal;
wherein the compensation data comprises threshold voltage information of a plurality of drive transistors corresponding to the plurality of pixel driving circuits and the changing analog data signal is acquired by performing a digital-to-analog conversion on the changing digital data signal by the drive module;
wherein the drive module is further configured to adjust the changing analog data signal and output the adjusted changing analog data signal to the plurality of pixel driving circuits according to the compensation data.

2. The display device according to claim 1, wherein the integration module comprises:
an operational amplifier, wherein a non-inverting terminal of the operational amplifier is configured to input a reference signal, an inverting terminal of the operational amplifier is configured to input the drive currents outputted by the plurality of pixel driving circuits, and an output terminal of the operational amplifier is configured to output the adjusted sampling signal; and
a storage element, wherein the storage element is configured to electrically connect the inverting terminal of the operational amplifier to the output terminal of the operational amplifier.

3. The display device according to claim 2, wherein the integration module further comprises:
a first switch module, configured to adjust the integration module to operate in an integration mode or in a following mode according to an on/off state of the first switch module.

4. The display device according to claim 3, wherein
a first terminal of the first switch module is electrically connected to the inverting terminal of the operational amplifier and a second terminal of the first switch module is electrically connected to the output terminal of the operational amplifier.

5. The display device according to claim 1, wherein the processing module comprises:
an analog-to-digital converter, configured to acquire the adjusted sampling signal and convert the adjusted sampling signal which is an analog sampling signal into a digital sampling signal; and
a timing controller, configured to output the changing digital data signal to the drive module, and is further configured to acquire the digital sampling signal and generate the compensation data according to the digital sampling signal and the changing digital data signal outputted to the drive module.

6. The display device according to claim 5, wherein the processing module further comprises:
a second switch module, configured to adjust a period during which the processing module receives the adjusted sampling signal according to an on/off state of the second switch module.

7. The display device according to claim 6, wherein a first terminal of the second switch module is electrically connected to an output terminal of the integration module and a second terminal of the second switch module is electrically connected to an input terminal of the analog-to-digital converter.

8. The display device according to claim 1, further comprising:
a multi-path selection module, configured to gate one pixel driving circuit of the plurality of pixel driving circuits at one moment to electrically connect the one pixel driving circuit to the integration module.

9. The display device according to claim 1, wherein each of the plurality of pixel driving circuits comprises:
a drive unit, configured to supply a drive current to a respective one of the plurality of light-emitting devices and comprises the plurality of drive transistors;
a data writing unit, configured to write the adjusted changing analog data signal outputted by the drive module to a control terminal of the drive unit;
a storage unit, configured to maintain a potential of the control terminal of the drive unit; and
a reset unit, configured to output the drive current generated by the drive unit to the integration module in the detection stage.

10. The display device according to claim 9, wherein a control terminal of the data writing unit is configured to input a first scan signal, and a first terminal of the data writing unit is configured to input the adjusted changing analog data signal outputted by the drive module;
the control terminal of the drive unit is electrically connected to a second terminal of the data writing unit, a first terminal of the drive unit is configured to input a first power signal, a second terminal of the drive unit is electrically connected to a first electrode of the respective one of the plurality of light-emitting devices, and a second electrode of the respective one of the plurality of light-emitting devices is configured to input a second power signal;
a first terminal of the storage unit is electrically connected to the control terminal of the drive unit, and a second terminal of the storage unit is electrically connected to the second terminal of the drive unit; and
a control terminal of the reset unit is configured to input a second scan signal, a first terminal of the reset unit is electrically connected to the second terminal of the drive unit, and a second terminal of the reset unit is electrically connected to the integration module.

11. The display device according to claim 2, wherein the storage element is a capacitor.

12. The display device according to claim 3, wherein in a case where the first switch module is in an OFF state, the integration module operates in an integration mode and performs the integration operation on the drive currents to achieve external compensation for threshold voltages of the drive transistors in the pixel driving circuits.

13. The display device according to claim 3, wherein in a case where the first switch module is in an ON state, the storage element is shorted by the first switch module, the integration module operates in a follow mode;
in the follow mode, an output voltage of the operational amplifier is equal to the voltage of the inverting terminal of the operational amplifier, and the non-inverting terminal of the operational amplifier inputs the reference signal.

14. The display device according to claim 3, wherein the first switch module comprises a field-effect transistor.

15. The display device according to claim 6, wherein in a case where the second switch module is in an ON state, the processing module receives the adjusted sampling signal, and in a case where the second switch module is in an OFF state, the processing module fails to receive the adjusted sampling signal.

16. The display device according to claim 6, wherein the second switch module comprises a field-effect transistor.

17. A driving method of a display device, comprising:
acquiring, by an integration module, drive currents outputted by the plurality of pixel driving circuits, performing an integral operation on the drive currents in a detection stage, adjusting a sampling signal according to an operation result, and outputting the adjusted sampling signal;
supplying, by a drive module, a changing analog data signal to each of the plurality of pixel driving circuits in the detection stage;
outputting, by a processing module, a changing digital data signal to the drive module, acquiring the adjusted sampling signal, and generating compensation data according to the adjusted sampling signal and the changing digital data signal outputted to the drive module; wherein the compensation data comprises threshold voltage information of a plurality of drive transistors corresponding to the plurality of pixel driving circuits, and the changing analog data signal is acquired by performing a digital-to-analog conversion on the changing digital data signal by the drive module; and
adjusting, by the drive module, the changing analog data signal and outputting the adjusted changing analog data signal to the plurality of pixel driving circuits according to the compensation data.

18. The driving method according to claim 17,
wherein supplying, by the drive module, the changing analog data signal to the plurality of pixel driving circuits in the detection stage comprises:
supplying, by the driving module, a data signal whose level value is stepped down to the plurality of pixel driving circuits in the detection stage; and
wherein acquiring, by the processing module, the adjusted sampling signal, and generating the compensation data according to the adjusted sampling signal and the changing digital data signal outputted to the drive module comprises:
comparing, by the processing module, level values of sampling signals sampled at two adjacent samplings to each other, acquiring the changing digital data signal outputted to the drive module at a moment when the level values of the sampling signals sampled at the two adjacent samplings are equal, and acquiring the compensation data according to the changing digital data signal outputted to the drive module at the moment.
